(19) United States
(12) Patent Application Publication
(10) Pub. No.: US 2012/0105776 A1
(43) Pub. Date: May 3, 2012

(54) LIQUID CRYSTAL DISPLAY PANEL AND METHOD FOR FORMING LIQUID CRYSTAL LAYER THEREOF

(75) Inventors: CHIH-WEI LIN, Taichung City (TW); Min-Cheng Wang, Zhonghe City (TW); Chih-Yu Hsu, Zhonghe City (TW)

(73) Assignee: CHUNGHWA PICTURE TUBES, LTD., Taoyuan (TW)

(21) Appl. No.: 13/073,013

(22) Filed: Mar. 28, 2011

(30) Foreign Application Priority Data
Nov. 3, 2010 (TW) 099137798

(51) Int. Cl. G02F 1/1335; H01J 9/26

(52) U.S. Cl. 349/106; 445/25

(57) ABSTRACT

A liquid crystal display panel includes a transistor array substrate, a color filter substrate, a liquid crystal layer, and a sealant material. The transistor array substrate includes a transparent substrate, a transistor array, and a plurality of peripheral wires. The transparent substrate has a display region and a non-display region, and the non-display region is located beside the display region. The transistor array is disposed in the display region. The peripheral wires are disposed in the non-display region and electrically connected with the transistor array. A transmittance of the non-display region is less than 30%. The liquid crystal layer is disposed between the color filter substrate and the transistor array substrate. The sealant material is disposed in the non-display region and connected between the color filter substrate and the transistor array substrate. The sealant material surrounds the liquid crystal layer.

### CROSS-REFERENCE TO RELATED APPLICATION

This application claims the benefit of Taiwan Patent Application No. 099137798, filed on Nov. 3, 2010, which is hereby incorporated by reference for all purposes as if fully set forth herein.

### BACKGROUND OF THE INVENTION

1. Field of Invention

The present invention relates to a liquid crystal display panel and a method for forming a liquid crystal layer thereof, and more particularly to a liquid crystal display panel fabricated by a one drop filling (ODF) process and a method for forming a liquid crystal layer thereof.

2. Related Art

An ODF process has been developed in the existing liquid crystal display panel fabrication technology. The process is to fill a liquid crystal material into a closed region surrounded by a sealant in a dropping manner, thus forming a liquid crystal layer. After the liquid crystal material is dropped into the closed region, a transistor array substrate and a color filter substrate are presently bound together through the sealant.

Then, the sealant is irradiated with ultraviolet light, so as to perform a photo-curing process. The sealant mostly has a photo-curing characteristic, so when the sealant is irradiated with the ultraviolet light, the sealant is partially cured and bonds the transistor array substrate and the color filter substrate. Next, the sealant is heated to perform a heat curing process, so that the sealant is completely cured. Thus, the transistor array substrate, the color filter substrate, and the sealant can seal the liquid crystal material, thereby forming the liquid crystal layer.

Liquid crystal displays are mainstream products on the current display market and thus having a great market demand. Hence, how to shorten the time for fabricating a liquid crystal display panel to increase the throughput of liquid crystal displays is a topic that many liquid crystal display manufacturers strive to research.

### SUMMARY OF THE INVENTION

The present invention is directed to a liquid crystal display panel, which is able to be fabricated by dropping a liquid crystal material under the condition of skipping the photo-curing process.

The present invention is further directed to a method for forming a liquid crystal layer of a liquid crystal display panel, so as to skip the photo-curing process and thus shorten the time for fabricating the liquid crystal display panel.

The present invention provides a liquid crystal display panel including a transistor array substrate, a color filter substrate, a liquid crystal layer, and a sealant material. The transistor array substrate includes a transparent substrate, a transistor array, and a plurality of peripheral wires. The transparent substrate has a display region and a non-display region, wherein the non-display region is located beside the display region. The transistor array is disposed in the display region. The peripheral wires are disposed in the non-display region and electrically connected with the transistor array, wherein a transmittance of the non-display region is less than 30%. The liquid crystal layer is disposed between the color filter substrate and the transistor array substrate. The sealant material is disposed in the non-display region and connected between the color filter substrate and the transistor array substrate, wherein the sealant material surrounds the liquid crystal layer.

The present invention further provides a method for forming a liquid crystal layer of a liquid crystal display panel including the following steps. First, a sealant material is formed on a first substrate, wherein the sealant material surrounds to form a closed region. Next, a liquid crystal material is dropped into the closed region. After dropping the liquid crystal material into the closed region, make the sealant material bond to a second substrate, wherein the sealant material is located between the first substrate and the second substrate. Then, the sealant material under a condition that the sealant material is not subjected to a photo-curing process is heated.

Based on the above description, the present invention can skip the photo-curing process by using a sealant material, so as to shorten the time for fabricating the liquid crystal display panel, thereby increasing the throughput of liquid crystal displays and satisfying the current market demand for the liquid crystal displays.

In order to make the aforementioned features and advantages of the present invention more comprehensible, embodiments accompanied with figures are described in detail below.

### BRIEF DESCRIPTION OF THE DRAWINGS

The present invention will become more fully understood from the detailed description given herein below for illustration only, and thus are not limitative of the present invention, and wherein:

FIG. 1A is a schematic sectional view of a liquid crystal display panel according to an embodiment of the present invention;

FIG. 1B is a schematic top view of the transistor array substrate in FIG. 1A;

FIG. 1C is a schematic sectional view of the transistor array substrate in FIG. 1B after combined with a color filter substrate along a section line J-J; and

FIG. 2A to FIG. 2C are schematic views of a method for forming the liquid crystal layer of the liquid crystal display panel in FIG. 1A.

### DETAILED DESCRIPTION OF THE INVENTION

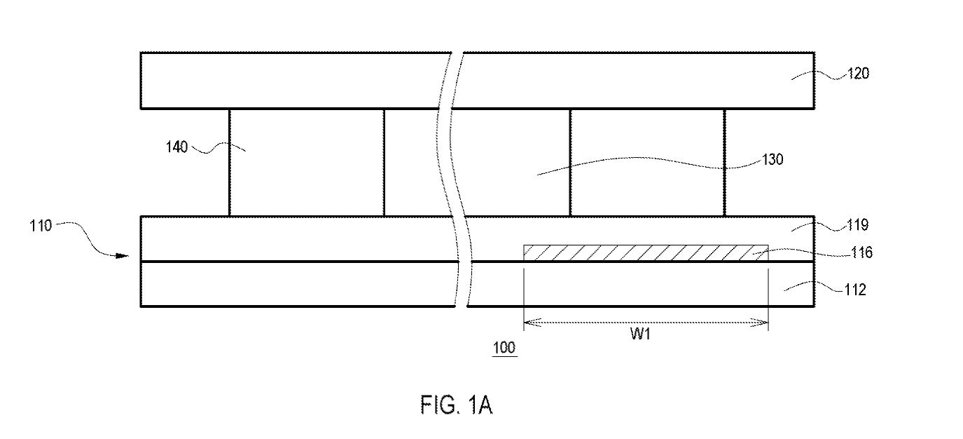

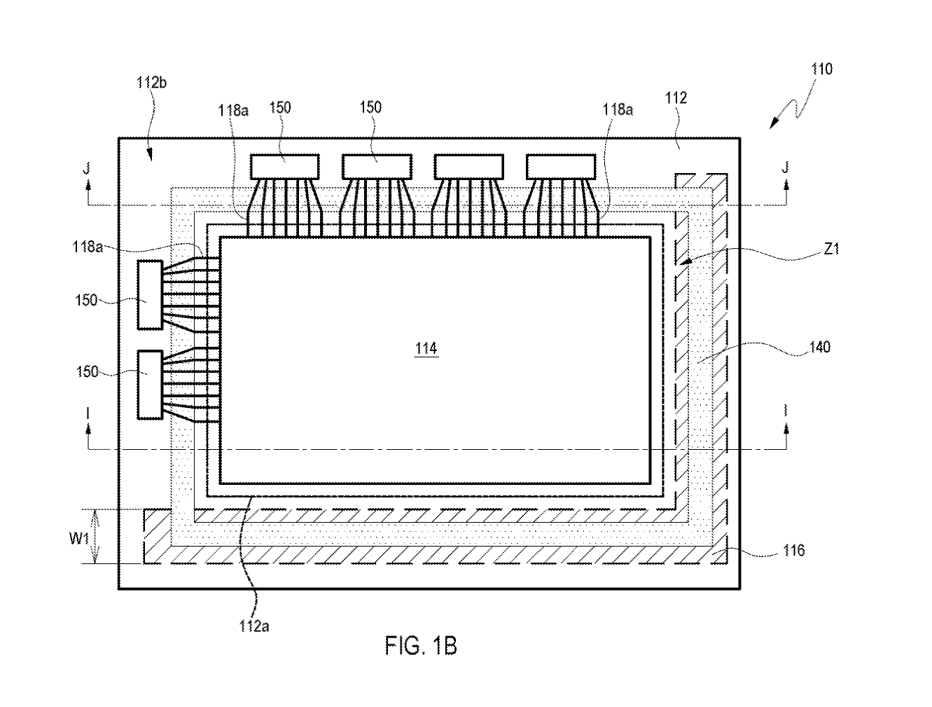

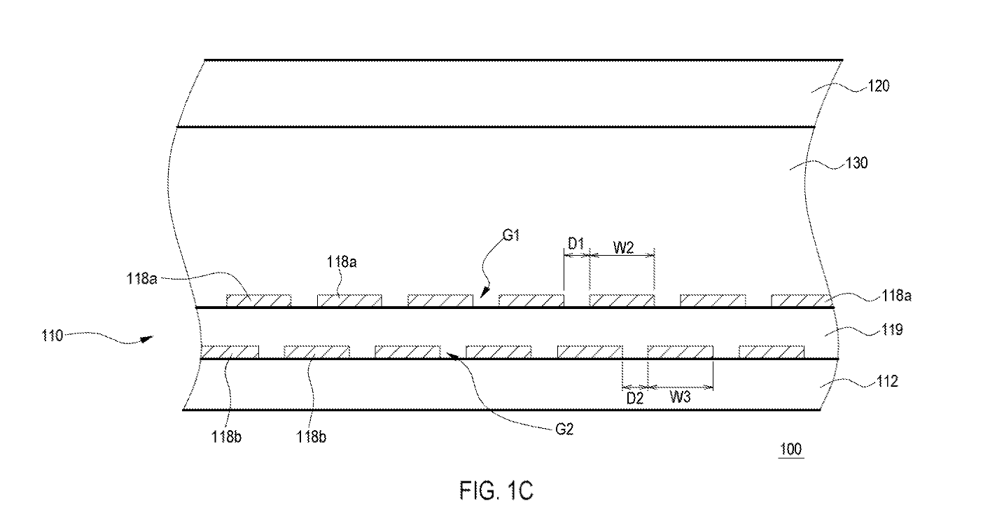

FIG. 1A is a schematic sectional view of a liquid crystal display panel according to an embodiment of the present invention. Referring to FIG. 1A, a liquid crystal display panel 100 includes a transistor array substrate 110, a color filter substrate 120, a liquid crystal layer 130, and a sealant material 140. The liquid crystal layer 130 is formed of a liquid crystal material in a liquid state and disposed between the color filter substrate 120 and the transistor array substrate 110. The sealant material 140 is connected between the color filter substrate 120 and the transistor array substrate 110.

The sealant material 140 is able to bond the color filter substrate 120 and the transistor array substrate 110, so that the color filter substrate 120 and the transistor array substrate 110 are combined together stably. A material of the sealant material 140 can include a resin material and a heat curing agent, so the sealant material 140 is a thermal curing adhesive. Specifically, the sealant material 140 is able to be cured through a heat curing process, that is, the sealant material 140 can be cured by heating. Moreover, the resin material can include a polymethylmethacrylate (PMMA, which is also called acrylate) resin and an epoxy resin.

In this embodiment, the sealant material 140 may not contain any photo-curing adhesives. That is to say, even if the sealant material 140 is irradiated with ultraviolet light or visible light, the sealant material 140 cannot be cured. Therefore, the ultraviolet light or the visible light on the whole does not cause a chemical reaction for curing the sealant material 140.

FIG. 1B is a schematic top view of the transistor array substrate in FIG. 1A. The liquid crystal display panel 100 shown in FIG. 1A is drawn along a section line I-I after the transistor array substrate 110 in FIG. 1B is combined with the color filter substrate 120. Referring to FIG. 1A and FIG. 1B, the transistor array substrate 110 includes a transparent substrate 112, a transistor array 114, and a plurality of peripheral wires 116 and 118a.

The transparent substrate 112 has a display region 112a and a non-display region 112b, and the non-display region 112b is located beside the display region 112a and can surround the display region 112a. The transistor array 114 is disposed in the display region 112a, and the peripheral wires 116 and 118a are all disposed in the non-display region 112b. The peripheral wires 116 and 118a are electrically connected with the transistor array 114 and all can be metal wires. The number of the peripheral wire 116 is one, and the number of the peripheral wires 118a is plural.

The transistor array 114 can be a transistor array of a conventional liquid crystal display panel and include a plurality of pixel units (not shown), a plurality of scanning lines (not shown), and a plurality of data lines (not shown). When the transistor array 114 is a conventional transistor array, even if a construction of the transistor array 114 is not introduced and shown, people with ordinary skill in the art of the present invention still know the construction of the transistor array 114.

The peripheral wire 116 can be a common wire and used to transmit a common voltage. Each of the peripheral wires 118a is electrically connected with the scanning line or the data line in the transistor array 114. In this embodiment, the liquid crystal display panel 100 can further include a plurality of chips 150, and the chips 150 are electrically connected with the peripheral wires 118a, so that the chips 150 can output electrical signals to the transistor array 114 from the peripheral wires 118a, so as to enable the liquid crystal display panel 100 to operate. Moreover, a wire width W1 of the peripheral wire 116 can be longer than or equal to 50 micrometers (μm).

The sealant material 140 is disposed in the non-display region 112b and surrounds the liquid crystal layer 130. Specifically, a shape of the sealant material 140 can be a closed ring, and the liquid crystal layer 130 is located in a closed region Z1 surrounded by the sealant material 140. The sealant material 140 tightly binds the color filter substrate 120 and the transistor array substrate 110, so that the transistor array substrate 110, the color filter substrate 120, and the sealant material 140 seal the liquid crystal layer 130 to prevent the liquid crystal material from leaking.

Additionally, the transistor array substrate 110 can further include a dielectric layer 119. The peripheral wire 116 is disposed on the transparent substrate 112 and covered by the dielectric layer 119. Moreover, a material of the dielectric layer 119 can be an insulating material such as silicon dioxide or silicon nitride, and the dielectric layer 119 can also be a gate insulation layer covering the scanning lines.

FIG. 1C is a schematic sectional view of the transistor array substrate in FIG. 1B after combined with the color filter substrate along a section line J-J. Referring to FIG. 1B and FIG. 1C, the transistor array substrate 110 can further include a plurality of peripheral wires 118b, and the peripheral wires 118b can also be metal wires. The peripheral wires 118a are first wires, and the peripheral wires 118b are second wires. Therefore, all of the peripheral wires in this embodiment include a plurality of first wires (that is, the peripheral wires 118a) and a plurality of second wires (that is, the peripheral wires 118b).

The peripheral wires 118a and 118b and the dielectric layer 119 are all disposed on the transparent substrate 112. The dielectric layer 119 completely covers the peripheral wires 118b, and the peripheral wires 118a are disposed on the dielectric layer 119 and partially cover the dielectric layer 119. Therefore, the dielectric layer 119 is located between the peripheral wires 118a and the peripheral wires 118b, as shown in FIG. 1C. Moreover, the wire width of each peripheral wire can be longer than or equal to 50 micrometers. Thus, not only the wire width W1 of the peripheral wire 116 can be longer than or equal to 50 micrometers, but also a wire width W2 of the peripheral wires 118a and a wire width W3 of the peripheral wires 118b both can be longer than or equal to 50 micrometers.

A transmittance of the non-display region 112b is less than 30%, and the transmittance means a proportion of light transmitting through the non-display region 112b. The higher the transmittance is, the greater the proportion of light transmitting through the non-display region 112b is, for example, the more transparent a color of the non-display region 112b tends to be. The lower the transmittance is, the smaller the proportion of light transmitting the non-display region 112b is, for example, the darker the color of the non-display region 112b tends to be. Additionally, when the transmittance is equal to zero, it means that light basically cannot transmit through the non-display region 112b.

In this embodiment, the transmittance basically can be defined by the following mathematical formula (1).

$$T = \frac{D}{D + W} \qquad ( 1 )$$

In mathematical formula (1), T is a transmittance and satisfied about a relationship of T<0.3; W is a wire width of a peripheral wire, such as the wire width W1, W2, or W3; and D is a distance between two adjacent peripheral wires, such as a distance D1 between two adjacent peripheral wires 118a, or a distance D2 between two adjacent peripheral wires 118b.

Additionally, the transmittance of the non-display region 112b is not only less than 0.3, but also can be equal to zero. Specifically, a gap G1 exists between two adjacent peripheral wires 118a, and a gap G2 exists between two adjacent peripheral wires 118b. The peripheral wires 118a are located just above the gaps G2 respectively and can cover the gaps G2 respectively. Therefore, when the peripheral wires 118a and 118b are all metal wires, light from the transparent substrate 112 are blocked by the peripheral wires 118a and 118b and cannot transmit through the non-display region 112b, so that the transmittance of the non-display region 112b can be equal to zero.

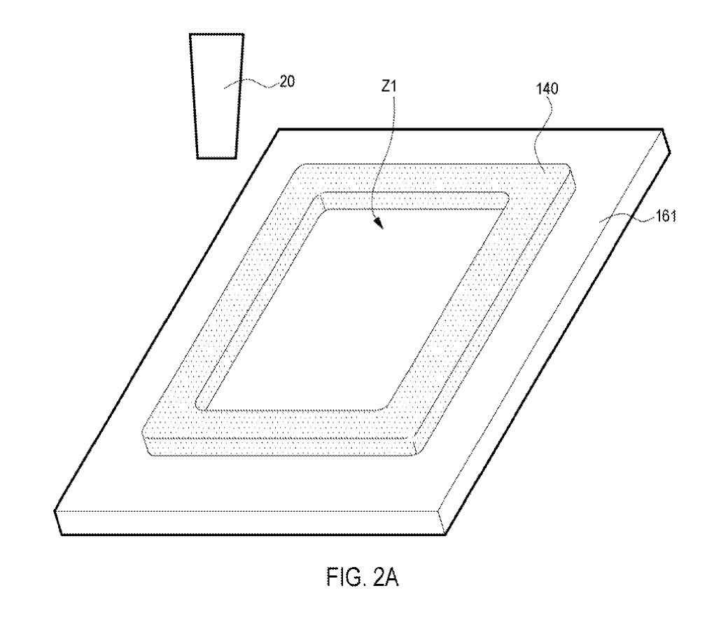

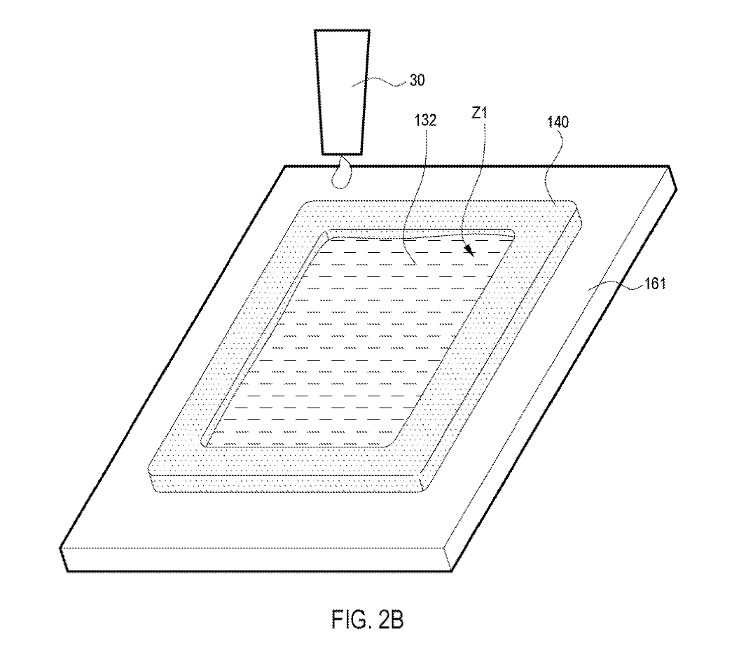

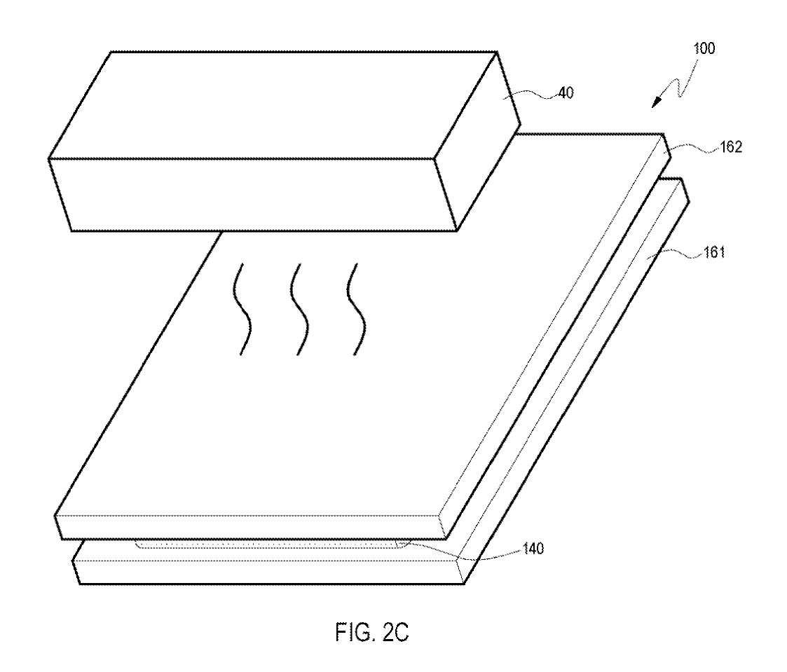

FIG. 2A to FIG. 2C are schematic views of a method for forming the liquid crystal layer of the liquid crystal display panel in FIG. 1A. Referring to FIG. 2A, a method for forming the liquid crystal layer 130 includes the following steps. Firstly, the sealant material 140 is formed on a first substrate 161. The first substrate 161 may be the transistor array substrate 110 or the color filter substrate 120, and the sealant material 140 can be coated by an adhesive-spreading apparatus 20 on the first substrate 161. Additionally, at this time, the sealant material 140 can surround to form the closed region Z1. The closed region Z1 is completely surrounded by the sealant material 140, and the sealant material 140 does not have any notch.

Referring to FIG. 2B, then, a liquid crystal material 132 is dropped into the closed region Z1. The liquid crystal material 132 can be dropped into the closed region Z1 from a table 30. Because the closed region Z1 is completely surrounded by the sealant material 140 without any notch, the sealant material 140 and the closed region Z1 can form a tank structure. In this way, the liquid crystal material 132 can be accommodated in the closed region Z1.

Referring to FIG. 2C, after the liquid crystal material 132 is dropped into the closed region Z1, make the sealant material 140 bond to a second substrate 162. The sealant material 140 is located between the first substrate 161 and the second substrate 162. Because the sealant material 140 is a thermal curing adhesive, the sealant material 140 before heated has viscosity, thereby bonding the first substrate 161 and the second substrate 162.

The second substrate 162 can also be the transistor array substrate 110 or the color filter substrate 120. However, when the second substrate 162 is the transistor array substrate 110, the first substrate 161 is the color filter substrate 120. When the second substrate 162 is the color filter substrate 120, the first substrate 161 is the transistor array substrate 110. Therefore, the first substrate 161 and the second substrate 162 both cannot be the transistor array substrate 110 or the color filter substrate 120 simultaneously.

Then, under the condition that the sealant material 140 is not subjected to a photo-curing process, that is, in the case that the sealant material 140 is not irradiated with ultraviolet light or visible light, the sealant material 140 is heated, so as to perform a heat curing process. The sealant material 140 can be baked through a heating apparatus 40. In this way, the sealant material 140 can be cured, and the liquid crystal material 132 is able to be sealed to form the liquid crystal layer 130 (referring to FIG. 1A). Till now, the fabrication of the liquid crystal display panel 100 is basically completed.

It is noted that, the sealant material 140 can be selected from specific adhesive materials sold by current raw material suppliers on the market, for example, adhesive materials available from SEKISUI CHEMICAL CO., LTD., like SR series adhesive materials. The specific adhesive materials commercially available on the market enable the sealant material 140 before heating to have a good structural strength, so that in the process that the sealant material 140 bonds the second substrate 162, the liquid crystal material 132 does not penetrate through the sealant material 140 under the influence of an atmospheric pressure difference, thereby achieving the effect of preventing the liquid crystal material 132 from leaking.

Moreover, in the process of heating the sealant material 140, the specific adhesive materials further can reduce the substance from the sealant material 140 dissolved into the liquid crystal material 132, thereby reducing the influence on liquid crystal molecular arrangement and avoiding from damaging the picture quality of the liquid crystal display panel 100. Furthermore, the adhesive materials commercially available on the market further can maintain the adhesion strength of the sealant material 140 before heated, so as to reduce the occurrence of the situation that the first substrate 161 is separated from the second substrate 162 because of insufficient adhesion strength.

Furthermore, the specific adhesive materials further can increase a curing speed of the sealant material 140 during the heating and reduce the change in the viscosity of the sealant material 140, thereby enabling to shorten the time for heating the sealant material 140.

For example, in the process of heating the sealant material 140, a temperature for heating the sealant material 140 can be between 120° C. and 150° C., and the time for heating the sealant material 140 may be between 30 minutes and 90 minutes, for example, about 60 minutes.

In view of the above statement, compared with the conventional ODF process, the present invention can skip the photo-curing process through the sealant material, so as to shorten the time for fabricating the liquid crystal display panel, thereby increasing a throughput of liquid crystal displays and satisfying the current market demand for the liquid crystal displays.

Next, because the present invention can skip the photo-curing process, the non-display region of the transistor array substrate enables to have a transmittance of less than 30%, and even can have a transmittance of equal to zero. In this way, when a plurality of peripheral wires in the non-display region are designed, the transmission of light through the non-display region does not need to be considered, so that the peripheral wires have various layouts. For example, increasing wire widths of the peripheral wires to reduce the resistance of the peripheral wires, or increasing the distribution density of the peripheral wires to enhance a resolution of the liquid crystal display panel.

Furthermore, the sealant material of the present invention can be selected from the specific adhesive materials, so as to increase the curing speed of the sealant material and enable the temperature for heating the sealant material to be between 120° C. and 150° C., and the time for heating the sealant material to be between 30 minutes and 90 minutes. Compared with the prior art, the present invention has a short time for heating the sealant material, and thus the time for fabricating the liquid crystal display panel can be further effectively reduced.

Although the present invention has been described above through the preferred embodiments, they are not intended to limit the present invention. Equivalent replacements of variations and modifications made by persons skilled in the art without departing from the spirit and the scope of the present invention still fall within the protection scope of the present invention.

What is claimed is:

1. A liquid crystal display panel, comprising:
a transistor array substrate, comprising:
a transparent substrate, having a display region and a non-display region, wherein the non-display region is located beside the display region;
a transistor array, disposed in the display region; and
a plurality of peripheral wires, disposed in the non-display region and electrically connected with the transistor array, wherein a transmittance of the non-display region is less than 30%;
a color filter substrate;
a liquid crystal layer, disposed between the color filter substrate and the transistor array substrate; and
a sealant material, disposed in the non-display region and connected between the color filter substrate and the transistor array substrate, wherein the sealant material surrounds the liquid crystal layer.

2. The liquid crystal display panel according to claim 1, wherein a wire width of each of the peripheral wires is longer than or equal to 50 micrometers.

3. The liquid crystal display panel according to claim 1, wherein a shape of the sealant material is a closed ring.

4. The liquid crystal display panel according to claim 1, wherein the transistor array substrate further comprises a dielectric layer, the peripheral wires comprise a plurality of first wires and a plurality of second wires, the first wires and the dielectric layer are disposed on the transparent substrate, the dielectric layer covers the second wires, and the first wires are disposed on the dielectric layer.

5. The liquid crystal display panel according to claim 4, wherein a gap exists between two adjacent second wires, and the first wires are located just above the gaps respectively.

6. The liquid crystal display panel according to claim 5, wherein the second wires cover the gaps respectively.

7. The liquid crystal display panel according to claim 1, wherein a material of the sealant material comprises a resin material and a heat curing agent.

8. The liquid crystal display panel according to claim 7, wherein the resin material comprises a PMMA resin and an epoxy resin.

9. A method for forming a liquid crystal layer of a liquid crystal display panel, comprising:
forming a sealant material on a first substrate, wherein the sealant material surrounds to form a closed region;
dropping a liquid crystal material into the closed region;
after dropping the liquid crystal material into the closed region, making the sealant material bond to a second substrate, wherein the sealant material is located between the first substrate and the second substrate; and
heating the sealant material under a condition that the sealant material is not subjected to a photo-curing process.

10. The method for forming a liquid crystal layer of a liquid crystal display panel according to claim 9, wherein the first substrate is a transistor array substrate, and the second substrate is a color filter substrate.

11. The method for forming a liquid crystal layer of a liquid crystal display panel according to claim 9, wherein the first substrate is a color filter substrate, and the second substrate is a transistor array substrate.

12. The method for forming a liquid crystal layer of a liquid crystal display panel according to claim 9, wherein in a process of heating the sealant material, a temperature for heating the sealant material is between 120° C. and 150° C., and a time for heating the sealant material is between 30 minutes and 90 minutes.

13. The method for forming a liquid crystal layer of a liquid crystal display panel according to claim 9, wherein a material of the sealant material comprises a resin material and a heat curing agent.

14. The method for forming a liquid crystal layer of a liquid crystal display panel according to claim 13, wherein the resin material comprises a PMMA resin and an epoxy resin.
